(19) United States
(12) Patent Application Publication
(10) Pub. No.: US 2024/0226716 A1
(43) Pub. Date: Jul. 11, 2024

(54) DIRECTIONAL PADS COMPRISING A FORCE SENSOR AND METHODS OF USING THE SAME

(71) Applicant: Dell Products L.P., Round Rock, TX (US)

(72) Inventors: Wei-Hsiang Chi, Taipei (TW); Yi-Ming Chou, Taipei City (TW); Jheng-Ting Ye, Taipei (TW); Chiu-Jung Tsen, Zhubei (TW)

(73) Assignee: Dell Products L.P., Round Rock, TX (US)

(21) Appl. No.: 18/150,768

(22) Filed: Jan. 5, 2023

(51) Int. Cl. A63F 13/218; A63F 13/214; A63F 13/24; A63F 13/285

(52) U.S. Cl. CPC A63F 13/218; A63F 13/214; A63F 13/24; A63F 13/285

(57) ABSTRACT

A directional pad for a controller can comprise an upper surface, a touch sensor, and a force sensor. The touch sensor can be configured to measure a position at which an electrically-conductive object touches the upper surface of the directional pad. The force sensor can be configured to measure a force exerted on the upper surface of the directional pad.

### FIELD OF INVENTION

The present invention relates generally to directional pads for use on a controller and, more specifically, to directional pads that employ a touch sensor.

### BACKGROUND

Users commonly employ controllers to issue commands that cause actions to occur in a variety of applications, such as in software applications like gaming applications. For example, a controller may be in communication with an information handling system (e.g., a personal computer or a gaming console) that is running a gaming application, and user inputs into the controller may be translated into commands that cause in-game actions like character movement, menu selections, and/or the like.

Handheld controllers may offer better mobility than other user interfaces like a keyboard and mouse, but the constrained form factor of a handheld controller may impose limitations on its performance. For example, handheld controllers may not have as many user-inputs (e.g., buttons, thumbsticks, and/or the like) as other user interfaces like a keyboard and mouse, which may in turn limit the amount of commands that can be readily issued using the handheld controller. To illustrate, handheld controllers often include a directional pad that only allows for four directional inputs (e.g., up, down, left, and right), which limits the extent to which the directional pad can be used to cause movement, scroll through options in a software application, and/or the like. While additional buttons can provide more user inputs, doing so in a handheld controller with a small form factor can result in confusion and lead a user to make incorrect input selections when the controller is used.

### SUMMARY

Some of the present directional pads can allow a user to make more inputs than conventional directional pads in an intuitive manner such that the user can exercise better control in an application, such as in a gaming application. To do so, the directional pad can comprise a touch sensor configured to measure a position at which an electrically-conductive object like a user's finger touches an upper surface of the directional pad and a force sensor that is configured to measure a force exerted on the directional pad's upper surface. Touching the upper surface can cause one or more touch-based actions in the application based on the position at which the upper surface is touched, and pressing and/or releasing the upper surface can cause one or more force-based actions in the application based on the force that is exerted on the upper surface. The combination of touch-based and force-based actions that can be prompted by the directional pad provides a higher degree of control that a user can readily learn. For example, the force-based actions can comprise movement in a first direction and movement in a second direction that is opposite and parallel to the second direction, while the touch-based actions can comprise movement in one or more (e.g., four or more) directions that are each perpendicular to the first and second directions such that the directional pad can be used to control movement in three dimensions. This higher degree of control can be employed with any suitable combination of touch-based and force-based actions for a particular application.

A user input device, such as a gaming controller, including one of the present directional pads and as disclosed in embodiments of this disclosure may be used by a user to provide user input to an information handling system. An information handling system generally processes, compiles, stores, and/or communicates information or data for business, personal, or other purposes thereby allowing users to take advantage of the value of the information. A user input device may be coupled to such an information handling system through wires and/or wireless connections, such as a universal serial bus (USB) connection or a Bluetooth, Wi-Fi, or other local area or personal area network connection. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such a gaming application, financial transaction processing, airline reservations, enterprise data storage, or global communications. In one example embodiment, an information handling system may execute a gaming application for processing user inputs from the gaming controller to generate an audio/visual (AV) stream for presentation to the user that includes a world generated based on the user input. In addition, information handling systems may include a variety of hardware and software components that may be configured to process, store, and communicate information and may include one or more computers systems, data storage systems, and networking systems.

Some of the present directional pads for a controller comprise an upper surface, a touch sensor, and a force sensor. Some of the present systems comprise an information handling system configured to execute a software application and a controller comprising a body and a directional pad that is coupled to the body and comprises an upper surface, a touch sensor, and a force sensor. The information handling system, in some systems, includes one or more processors, wherein at least one of the processor(s) is in electrical communication with an electronic display. The software application, in some systems, is a gaming application.

In some embodiments, the touch sensor of the directional pad is configured to measure a position at which an electrically-conductive object touches the upper surface of the directional pad. The touch sensor, in some embodiments, comprises a capacitive touch sensor. In some embodiments, the force sensor of the directional pad is configured to measure a force exerted on the upper surface of the directional pad. The force sensor, in some embodiments, comprises a piezoelectric force sensor.

In some embodiments, the directional pad comprises a linear resonant actuator that is configured to vibrate the upper surface of the directional pad in a direction that is substantially parallel with a vertical axis that extends through the upper surface of the directional pad. The upper surface of the directional pad, in some embodiments, has a circular planform.

In some systems, the controller is configured to send a signal to the information handling system that indicates the position at which the electrically-conductive object touches the upper surface of the directional pad. In some systems, the controller is configured to send a signal to the information handling system that indicates the force exerted on the upper surface of the directional pad.

In some systems, the information handling system is configured to cause one or more touch-based actions in the software application based on the position at which the electrically-conductive object touches the upper surface of the directional pad. In some systems, the information handling system is configured to cause one or more force-based actions in the software application based on the force that is exerted on the upper surface of the directional pad. The force-based action(s), in some systems, are different than the touch-based actions. The one or more force-based actions, in some systems, comprise a first force-based action that is caused when a first force is exerted on the upper surface of the directional pad and a second force-based action that is different than the first force-based action and is caused when a second force that is less than the first force is exerted on the upper surface of the directional pad.

In some systems, the controller comprises a plurality of buttons coupled to the body. The body of the controller, in some systems, has a main portion disposed between first and second gripping portions. Each of the gripping portions, in some systems, project rearwardly away from the main portion. In some systems, the directional pad is disposed closer to the first gripping portion than to the second gripping portion. In some systems, the directional pad is disposed closer to a front of the body than to a rearmost point of the first gripping portion. The buttons, in some systems, include four buttons that are each disposed closer to the second gripping portion than to the first gripping portion and closer to the front of the body than to a rearmost point of the second gripping portion.

Some of the present methods of controlling a software application comprise touching one or more regions of an upper surface of a directional pad of a controller, wherein the touching causes one or more touch-based actions in the software application. Some methods comprise pressing and releasing the upper surface of the directional pad, wherein the pressing and/or releasing cause one or more force-based actions in the software application that are different than the touch-based actions(s).

In some methods, pressing and releasing the directional pad is performed such that first and second forces are exerted on the upper surface of the directional pad, the second force being less than the first force. The one or more force-based actions, in some methods, comprise a first force-based action that is caused when the first force is exerted on the upper surface of the directional pad. In some methods, the one or more force-based actions comprise a second force-based action that is different than the first force-based action and is caused when the second force is exerted on the upper surface of the directional pad.

In some methods, the software application is a gaming application. The first force-based action, in some methods, comprises moving an avatar of the gaming application in a first direction. In some methods, the second force-based action comprises moving the avatar of the gaming application in a second direction that is opposite and parallel to the first direction. The one or more touch-based actions, in some methods, comprise moving the avatar of the gaming application in one or more directions that are each substantially perpendicular to the first and second directions.

In some methods, the touching comprises touching two or more regions of the upper surface of the directional pad. In some methods, the pressing and releasing comprise releasing the upper surface of the directional pad such that the upper surface is not touched.

The one or more touch-based actions, in some methods, comprise steering a vehicle of the gaming application. The first force-based action, in some methods, comprises accelerating the vehicle of the gaming application at a first rate. The second force-based action, in some methods, comprises accelerating the vehicle of the gaming application at a second rate that is slower than the first rate. In some methods, the force-based action(s) comprise decelerating the vehicle of the gaming application when the upper surface of the directional pad is released such that the upper surface is not touched.

In some methods, the one or more touch-based actions comprise moving an avatar of the gaming application in two or more angularly-disposed directions. The one or more force-based actions, in some methods, comprise moving the avatar of the gaming application from a standing position to a crouching position. In some methods, the one or more force-based actions comprise causing the avatar of the gaming application to jump when the upper surface of the directional pad is released such that the upper surface is not touched.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the terms “about” and “approximately” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” and “include” and any form thereof such as “includes” and “including” are open-ended linking verbs. As a result, a product or system that “comprises,” “has,” or “includes” one or more elements possesses those one or more elements but is not limited to possessing only those elements. Likewise, a method that “comprises,” “has,” or “includes” one or more steps possesses those one or more steps but is not limited to possessing only those one or more steps.

Any embodiment of any of the products, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above in order to change the scope of a given claim from what it would otherwise be using the open-ended linking verb.

Further, a device or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1A is a perspective view of one of the present directional pads that includes a force sensor configured to measure a force exerted on an upper surface of the directional pad.

FIGS. 1B-1F are top, front, right, rear, and left views, respectively, of the directional pad of FIG. 1A.

FIG. 1G is a schematic exploded view of the directional pad of FIG. 1A.

FIG. 2A is a top view of one of the present controllers that includes the directional pad of FIG. 1A.

FIG. 2B is a front view of the controller of FIG. 2A.

FIG. 3A illustrates one of the present systems that includes the controller of FIG. 2A and an information handling system that is configured to execute a software application like a gaming application.

FIG. 3B is a block diagram illustrating interactions between the controller and software on the information handling system of the system of FIG. 3A.

FIG. 4 illustrates actions that can be performed in a gaming application executed by the system of FIG. 3A using the directional pad, which can include moving an avatar in directions into or out of the screen by pressing and/or releasing the directional pad and in upward, downward, leftward, and/or rightward directions by touching the directional pad.

FIG. 5A illustrates actions that can be performed in a gaming application executed by the system of FIG. 3A using the directional pad, which can include causing forward, rearward, leftward, and/or rightward movement of an avatar by touching the directional pad.

FIG. 5B illustrates how, in the gaming application of FIG. 5A, pressing on the directional pad can cause the avatar to crouch.

FIG. 5C illustrates how, in the gaming application of FIG. 5A, releasing the pressed directional pad can cause the avatar to jump.

FIG. 6 illustrates actions that can be performed in a gaming application executed by the system of FIG. 3A using the directional pad, which can include accelerating and/or decelerating a vehicle by pressing and/or releasing the directional pad and steering the vehicle by touching the directional pad.

FIG. 7 is a schematic block diagram of one of the present information handling systems.

### DETAILED DESCRIPTION

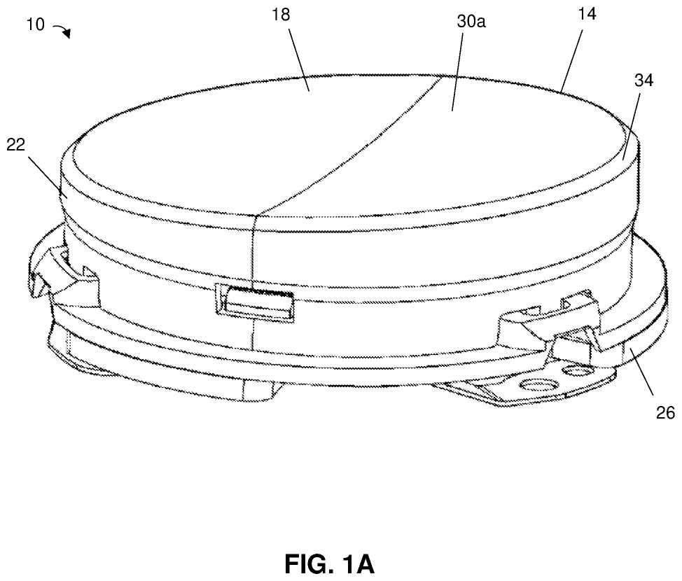

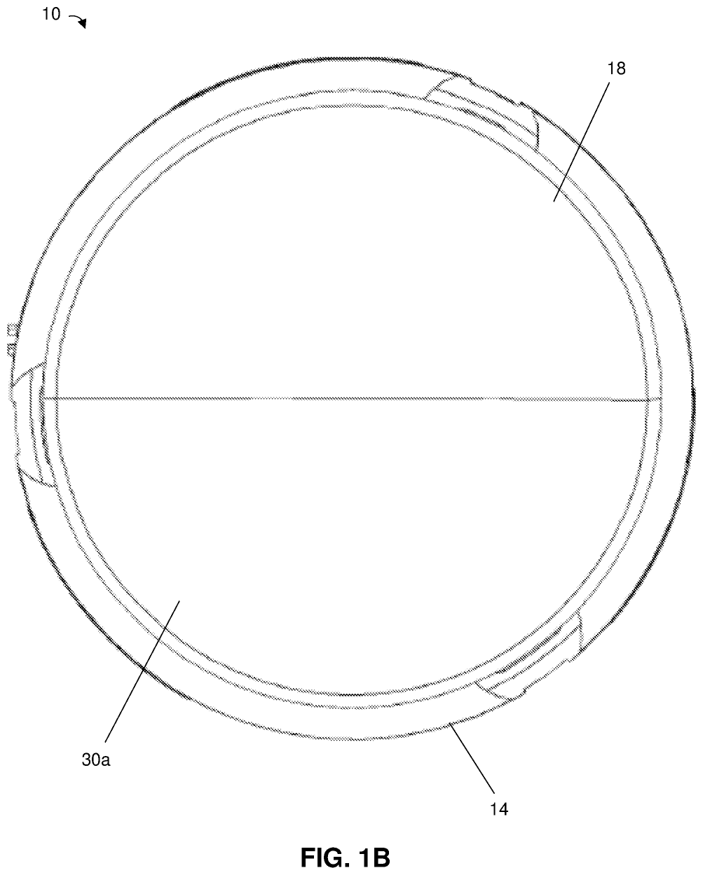

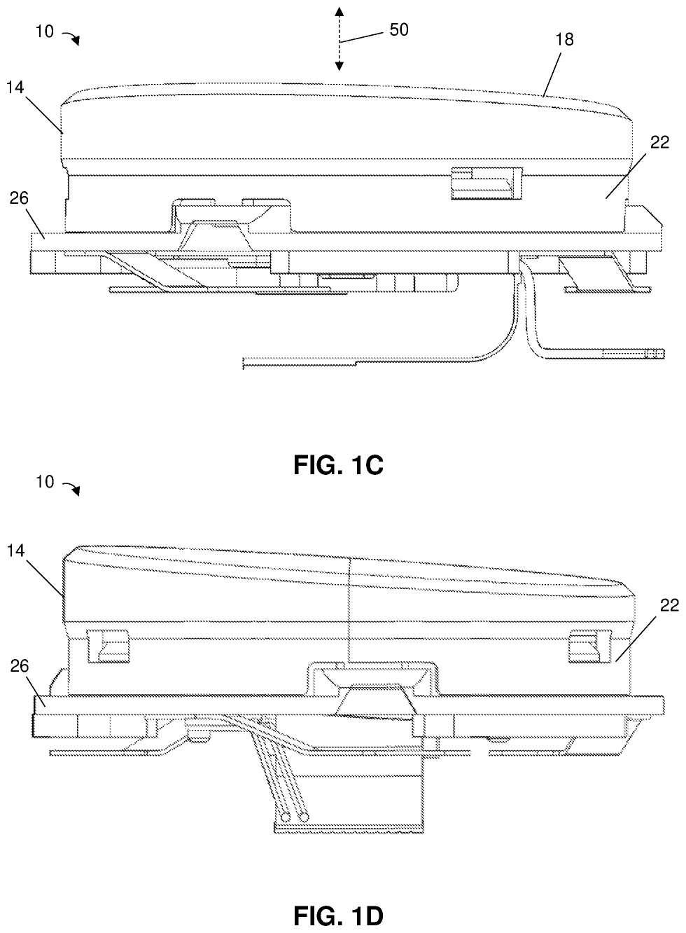

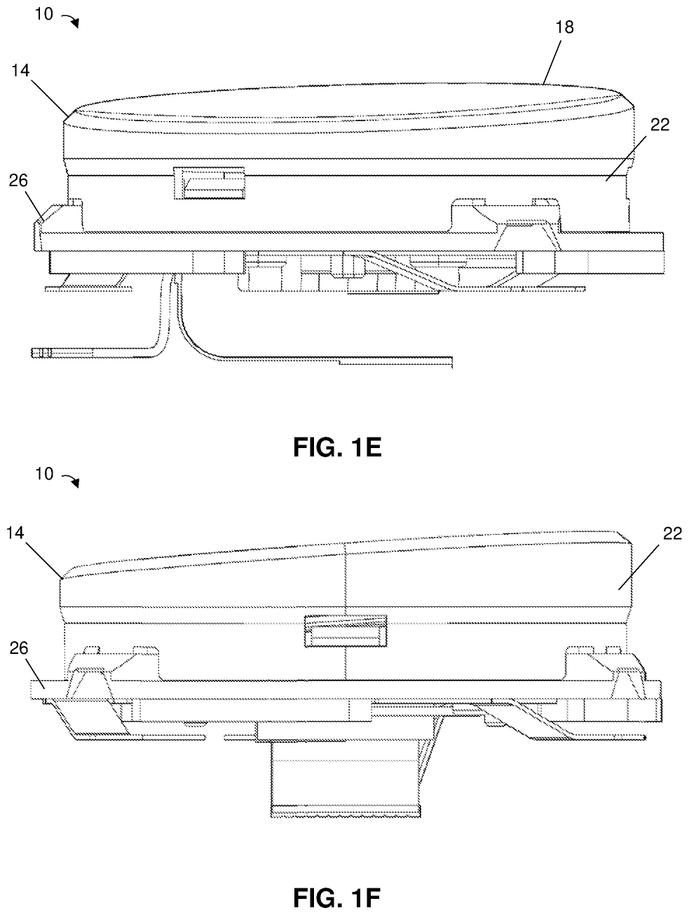

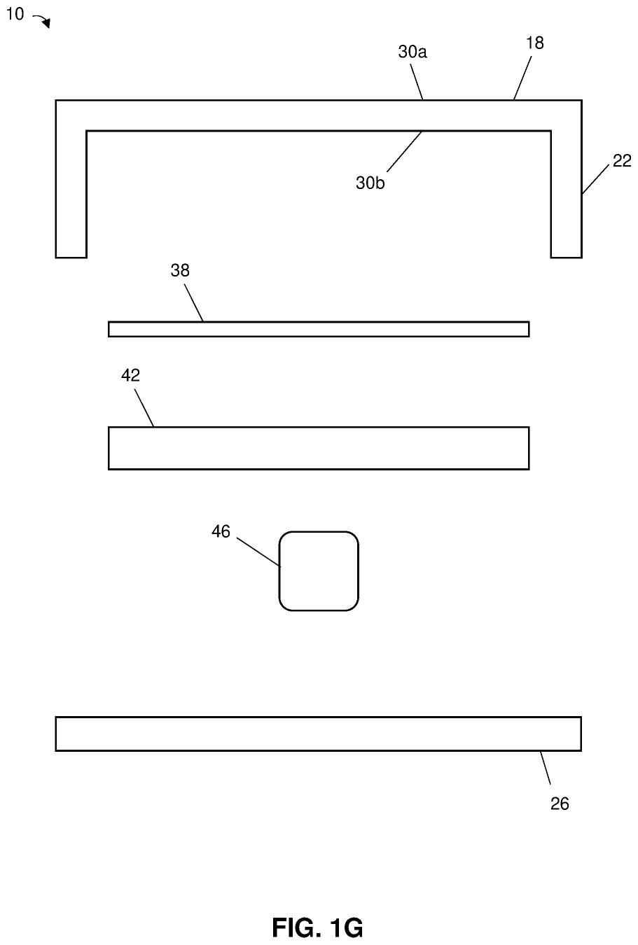

Referring to FIGS. 1A-1F, shown is an embodiment 10 of the present directional pads that has an upper surface 30a. Directional pad 10 can comprise a shell 14 having a top 18. Top 18 can define upper surface 30a and an opposing lower surface 30b, and a sidewall 22 can be disposed along at least a majority (up to and including substantially all) of a periphery 34 of the top and project downwardly away from the lower surface of the top. Shell 14 can also include a bottom 26 coupled to sidewall 22 such that the bottom, sidewall, and top 18 define an interior space that can house other components of directional pad 10; in other embodiments, however, the shell need not include an enclosing sidewall or bottom (e.g., with at least a portion of a controller body that the directional pad is coupled to defining a space with the top that houses other components of the directional pad).

Upper surface 30a of directional pad 10 can serve as the interface that a user interacts with to make user inputs with the directional pad. Directional pad 10 can include, for example, a touch sensor 38 (e.g., on a printed circuit board) that is configured to measure a position—such as an angular and/or radial position—at which an electrically-conductive object—such as the user's finger—touches upper surface 30a. As shown, touch sensor 38 can be coupled to lower surface 30b of shell 14's top 18, such as with an adhesive.

Touch sensor 38 can be a capacitive touch sensor having a plurality of electrodes to perform this touch-location determination. When a voltage is applied to an electrode of touch sensor 38, an electrostatic field can be generated; the electrostatic field can be distorted at a point where an electrically-conductive object like the user's finger touches upper surface 30a, thereby creating a change in a capacitance of the touch sensor at a location underlying that point. The change in capacitance be monitored (e.g., by a processor) to determine the touch location.

As one example, touch sensor 38 can be a self-capacitance touch sensor in which a voltage can be applied to each of the electrodes and a self-capacitance of the electrode (e.g., the capacitance between the electrode and a ground) can be monitored (e.g., by measuring a current through the electrode); when the electrically-conductive object touches a portion of upper surface 30a that overlies the electrode, the self-capacitance of the electrode can increase such that the touch sensor conveys a signal (e.g., a correspondingly higher current) indicating that the electrically-conductive object is touching the portion of the upper surface overlying the electrode. The electrodes can follow different paths to allow touch sensor 38 to measure when different portions of upper surface 30a are touched. For example, the electrodes can be arranged in a grid with a first set of the electrodes extending in a widthwise direction at different positions along a lengthwise direction that is perpendicular to the widthwise direction, and a second set of electrodes can extend along the lengthwise direction at different positions along the widthwise direction. A change in capacitance in one of the electrodes of the first set and one of the electrodes of the second set can thus indicate a position in the lengthwise direction and on the widthwise direction, respectively, where a touch occurs.

As another example, touch sensor 38 can be a mutual-capacitance touch sensor in which the electrodes include a first set of electrodes overlapping a second set of electrodes to define a plurality of junctions where the electrodes cross over one another (e.g., in the above-described grid pattern). A voltage can be applied to each of the electrodes of the first set and, at each of the junctions, a capacitance between the electrode of the first set and the electrode of the second set at the junction can be monitored (e.g., by measuring a voltage on the electrode of the second set); when the electrically-conductive object touches a portion of upper surface 30a that overlies the junction, the capacitance can decrease such that the touch sensor conveys a signal (e.g., a changed voltage on the electrode of the second set) indicating that the electrically-conductive object is touching the portion of the upper surface overlying the junction.

The above-described configurations of touch sensor 38 are illustrative and are not limiting; any suitable touch sensor configuration can be used to allow the touch sensor to be used to determine where an electrically-conductive object touches upper surface 30a. For example, in some embodiments, touch sensor 38 can be a resistive touch sensor instead of a capacitive touch sensor.

To increase the number of inputs that can be made with directional pad 10, the directional pad can also include a force sensor 42 that is configured to measure a force exerted on directional pad 10's upper surface 30a. As described in further detail below, with such force detection, directional pad 10 can be used to cause—in addition to one or more touch-based actions in a software application based on where upper surface 30a is touched—one or more force-based actions in the software application, thereby adding an additional dimension of control.

Force sensor 42 can comprise any suitable force sensor for force detection, such as a piezoelectric sensor. For example, pressing on top 18's upper surface 30a may cause deformation of piezoelectric sensor 42 that can be coupled to the top's lower surface 30b (e.g., beneath touch sensor 38), which can in turn change the resonant frequency, electrical impedance, decay time constant, and/or capacitance of the piezoelectric sensor; one or more of those changes can be monitored to detect the applied force.

While directional pad 10 can comprise a force sensor 42 that is distinct from touch sensor 38, in other embodiments the touch sensor can be used for force detection. For example, when the force a user's finger exerts on directional pad 10's upper surface 30a increases, the portion of the user's finger touching the upper surface can compress in the pressing direction and thereby expand in one or more directions perpendicular to the pressing direction such that the user's finger covers a larger portion of the upper surface. Touch sensor 38 can be used to monitor the extent of this increase in coverage (e.g., by measuring how many electrodes and/or electrode junctions are overlied by the portion of the finger touching upper surface 30a) and thus the force being exerted on the upper surface.

Directional pad 10 can also comprise a haptic actuator 46 to provide haptic feedback to a user when the user interfaces with the directional pad, such as to signal that an input onto upper surface 30a has been successfully registered. The use of haptic actuator 46 may be particularly advantageous when directional pad 10 employs touch sensor 38, which-unlike pressable buttons-might not itself provide haptic feedback. To provide haptic feedback, haptic actuator 46 can be configured to vibrate upper surface 30a (e.g., shell 14's top 18), such as in a direction that is substantially parallel with a vertical axis extending through the upper surface (e.g., in z-direction 50), which can simulate the feel of a button press. As shown, haptic actuator 46 comprises a linear resonant actuator; however, any suitable haptic actuator can be used, such as a piezoelectric actuator, an eccentric rotating mass actuator, and/or the like. Haptic actuator 46 can underlie shell 14's top 18 and touch sensor 38 such that the haptic actuator does not interfere with the touch sensor's position-measuring functionality.

Directional pad 10 can have any suitable geometry to facilitate a user's interaction with the directional pad. For example, because an action to be controlled can depend on the angular position of the input into directional pad 10 (e.g., whether a top, right, bottom, or left portion of upper surface 30a is selected), the upper surface of the directional pad can have a circular planform that is consonant with such angular-position-based control; however, in other embodiments, the upper surface can have a planform of any suitable shape, such as a polygonal (e.g., hexagonal, octagonal, or the like) shape. Additionally, to fit on a handheld controller, directional pad 10 can be relatively compact. For example, a transverse dimension (e.g., diameter) of upper surface 30a of directional pad 10 can be less than or equal to any one of, or between any two of, 55, 50, 45, 40, or 35, 30, 25, or 20 mm (e.g., between 20 and 40 mm). Upper surface 30a of directional pad 10 can also be smooth, and optionally concave, to facilitate a user's ability to scroll across the upper surface to make different inputs (e.g., without lifting a finger); such a configuration may be particularly well-suited with the directional pad including a touch sensor 38 as described above, with haptic actuator 62 vibrating the upper surface each time a different input is registered.

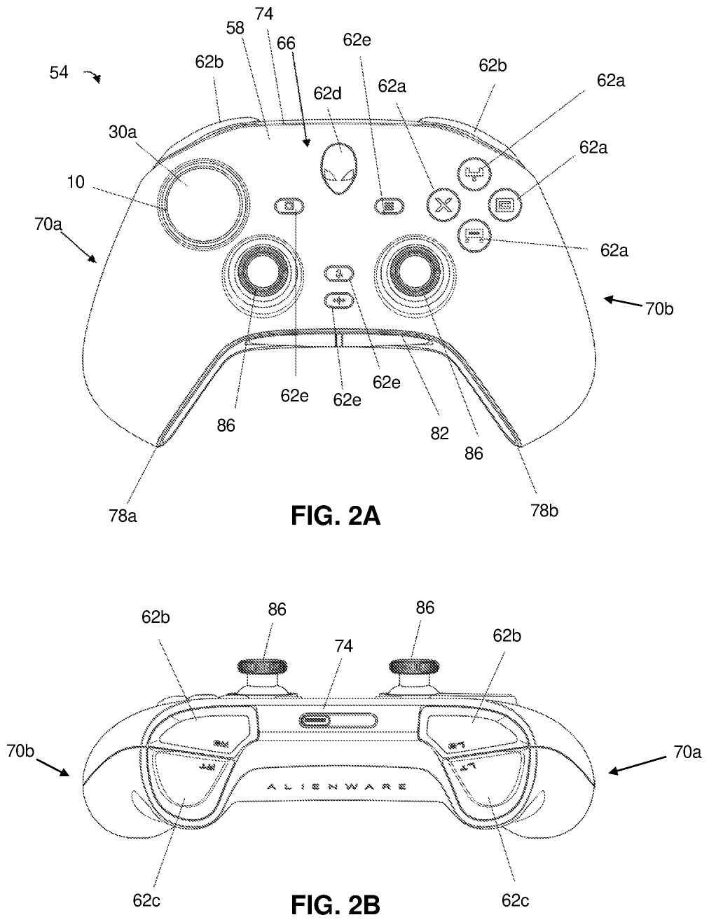

Referring additionally to FIGS. 2A and 2B, shown is a controller 54 that can comprise a body 58 and directional pad 10 (e.g., any of the directional pads described above) coupled to the body such that the directional pad's upper surface 30a faces upward to allow a user to interact with it. Controller 54 can also comprise a plurality of buttons 62a-62e coupled to the body, which can be used to make inputs other than those made using directional pad 10.

Controller 54 can have any suitable shape and any suitable configuration of buttons 62a-62e for control in a variety of applications, such as in software applications like gaming applications. As shown, controller 54 can be a handheld controller; the controller's body 58 can include a main portion 66 disposed between first and second gripping portions 70a and 70b, which can each project rearwardly away from the main portion to provide an area that allows a user to comfortably hold the controller. Directional pad 10 and buttons 62a-62e can be positioned such that a user has ready access to both the directional pad and the buttons to make inputs while holding controller 54. For example, directional pad 10 can be disposed closer to first gripping portion 70a than to second gripping portion 70b, while four buttons 62a (e.g., A-, B-, X-, and Y-buttons) can be disposed closer to the second gripping portion than to the first gripping portion. Additionally, directional pad 10 and buttons 62a can each be positioned in a front portion of controller 54's body 58 to facilitate access thereto, e.g., with the directional pad disposed closer to a front 74 of the body than to a rearmost point 78a of first gripping portion 70a (e.g., the point on the first gripping portion that is furthest from the body's front) and the four buttons each disposed closer to the front of the body than to a rearmost point 78b of second gripping portion 70b (e.g., the point on the second gripping portion that is furthest from the body's front).

Controller 54's buttons can also include two bumpers 62b, two triggers 62c, a power button 62d (e.g., to power the controller on and off), and a plurality of accessory buttons 62e (e.g., for menu selection, muting a microphone, initiating a voice command, and/or the like) to provide a user more control options. While directional pad 10 and buttons 62a, 62d, and 62e can be coupled to a top-facing surface of body 58 (e.g., with buttons 62d and 62e coupled to the body's main portion 66), bumpers 62b and triggers 62c can be coupled to a front-facing surface of the body's front 74 to allow controller 54's buttons to be packaged in a readily-holdable form factor that permits ready access to the buttons. As shown, for example, each of bumpers 62b and each of triggers 62c can be disposed closer to a respective one of first and second gripping portions 70a and 70b than to the other of the first and second gripping portions, with each bumper disposed over a respective one of the triggers.

Controller 54 can also include two thumbsticks 86, which can each be pivotably coupled to a top-facing surface of body 58 (e.g., such that the thumbstick can pivot about multiple axes) to allow a user to make, for example, directional inputs based on the pivoting angle and direction of the thumbstick. Thumbsticks 86 can be positioned such that a user can readily control them with the user's thumbs. For example, each of thumbsticks 86 can be coupled to body 58's main portion 66 and can be disposed closer to a rear 82 of the main portion of the body than to the body's front 74.

As shown, controller 54 can be a wireless controller (e.g., comprising a transceiver configured to transmit commands) to promote mobility. To power the components of controller 54, the controller can include a battery. In other embodiments, however, controller 54 can be a wired controller (e.g., with a wire configured to be coupled to an information handling system such that commands can be transmitted to the information handling system over the wire and power can be supplied to the controller over the wire).

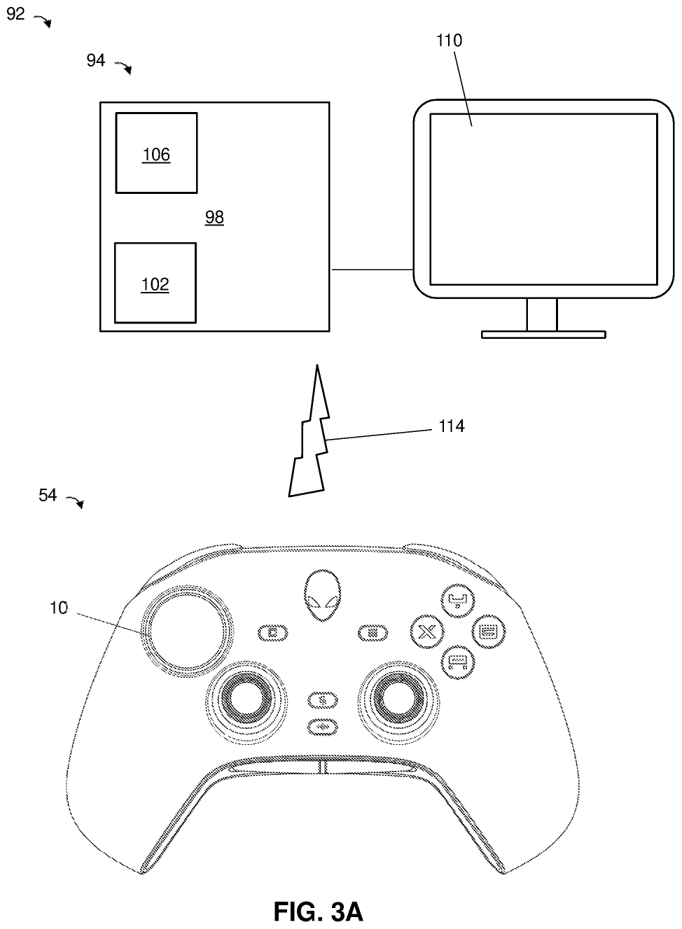

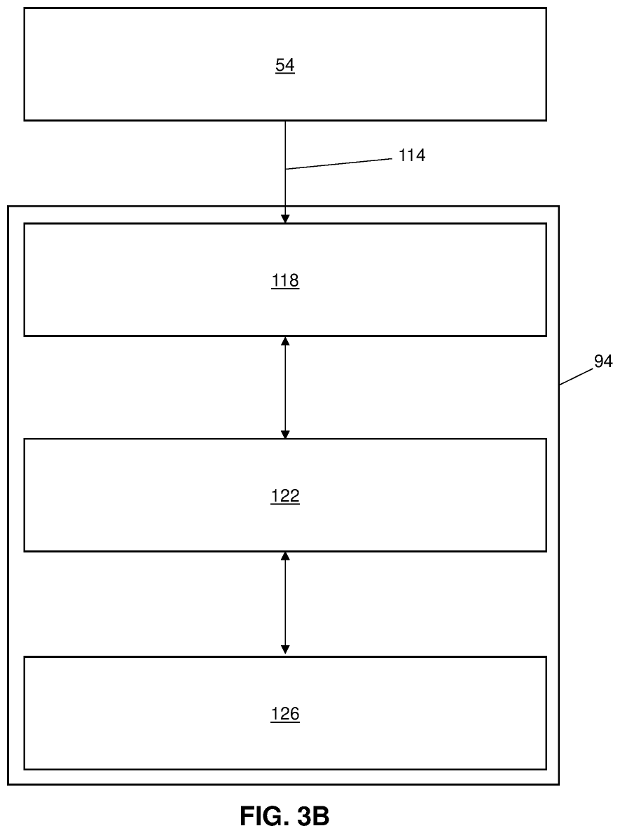

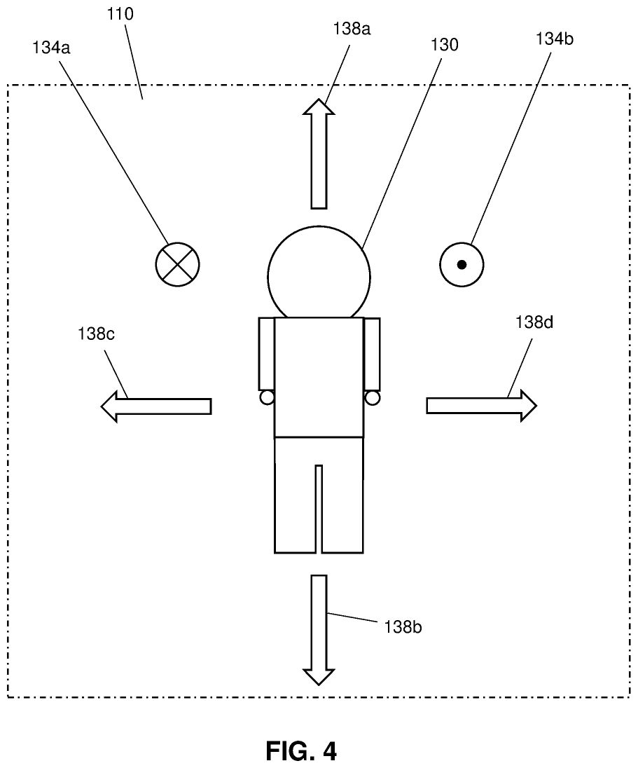

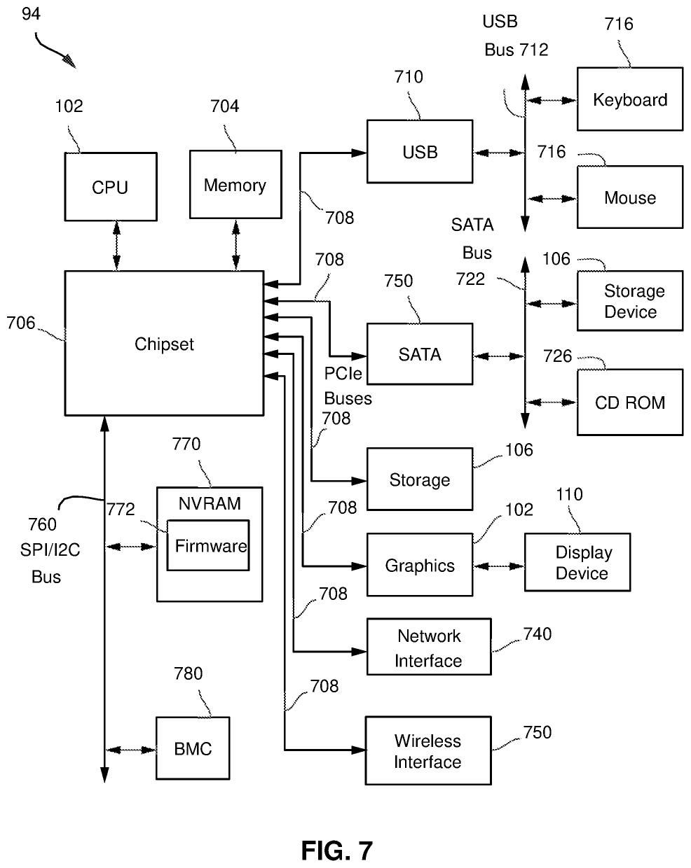

Referring to FIGS. 3A and 3B, shown is one of the present systems 92 that can be used to perform some of the present methods; while some methods are described with reference to system 92, the system is not limiting on those methods, which can be performed using any suitable system. System 92 can comprise controller 54 that includes directional pad 10 (e.g., any of those described above) and an information handling system 94 that is configured to execute a software application 126 such as a gaming application. Information handling system 94 can include any suitable platform for executing software application 126, such as a personal computer, a video game console, a tablet, and/or the like. As shown, information handling system 94 can comprise one or more processors 102 (e.g., one or more central processing units and/or one or more graphics processing units) and non-volatile memory 106 (e.g., a hard-disk drive and/or a solid-state drive) (e.g., as part of the information handling system's computing system 98); the non-volatile memory can, for example, store instructions for executing software application 126, which can be executed by at least one of the processor(s). Information handling system 94 can also comprise an electronic display 110 (e.g., a liquid-crystal display or an LED display) that can be in electrical communication with at least one of processor(s) 102 such that when software application 126 is executed and actions are performed in the application, the actions can be viewed on the electronic display (e.g., as an AV stream showing a world generated based on user input, in a gaming application). One exemplary configuration of information handling system 94 is described in further detail below with reference to FIG. 7.

Controller 54 can be in communication with information handling system 94. In this manner, controller 54 can be configured to send a signal 114 to information handling system 94 that indicates the position at which an electrically-conductive object (e.g., a user's finger) touches upper surface 30a of directional pad 10 and the force exerted on the upper surface. If controller 54 is a wireless controller, signal 114 can be an electromagnetic signal (e.g., a radiofrequency (RF) signal), and if the controller is a wired controller the signal can be an electric signal (e.g., conveyed by a wire connecting the controller to information handling system 94).

Information handling system 94 can be configured to cause greater than or equal to any one of, or between any two of, one, two, three, four, five, six, seven, eight, nine, ten, eleven, or twelve touch-based actions in software application 126 based on the position at which the electrically-conductive object touches directional pad 10's upper surface 30a and greater than or equal to any one of, or between any two of, one, two, three, four, five, six, seven, eight, nine, ten, eleven, or twelve force-based actions in the software application based on the force that is exerted on the directional pad's upper surface.

The touch-based action(s) can include, for example, movement of an avatar in a gaming application in greater than or equal to any one of, or between any two of, one, two, three, four, five, six, seven, eight, nine, ten, eleven, or twelve angularly-disposed directions (e.g., in two or more directions or at least four orthogonal directions, such as up, down, left, and right or forward, rearward, left, and right, when a front, rear, left, and right region, respectively, of directional pad 10's upper surface 30a is touched), scrolling through one or more options in software application 126, and/or the like. Directional pad 10's ability to be used to prompt movement in a large number of directions or for scrolling can be facilitated by its inclusion of touch sensor 38, which can provide a high degree of granularity in detecting where a touch occurs on upper surface 30a and thus which touch-based action (e.g., which movement direction) should be prompted. A touch-based action can be prompted by touching a single region of directional pad 10's upper surface 30a or multiple regions of the directional pad's upper surface; for example, translation of an avatar in a particular direction may be caused by touching a correspondingly-located region of the directional pad's upper surface (e.g., a left region for leftward movement, a right region for rightward movement, a front region for upward or forward movement, a rear region for downward or rearward movement, and/or the like), while scrolling or steering a vehicle (e.g., in a gaming application) may be caused by touching a first region of the upper surface and scrolling across the upper surface to touch a second region of the upper surface that is angularly disposed relative to the first region.

The force-based action(s) can be different than the touch-based action(s) to provide an additional dimension of control. One or more of the force-based action(s) can be prompted by pressing directional pad 10's upper surface 30a such that a level of force that is exerted on the upper surface reaches a certain range, with the exertion of difference forces (e.g., greater than or equal to any one of, or between any two of, two, three, four, five, or six different forces) resulting in different force-based actions. To illustrate, the force-based action(s) can comprise a first force-based action—for example, movement of an avatar in a first direction or into a crouching or prone position—that is caused when a first force is exerted on directional pad 10's upper surface 30a and a second force-based action that is different than the first force-based action—such as movement of an avatar in a second direction that is opposite and parallel to the first direction or into a less-crouched position—and is caused when a second force that is less than the first force is exerted on the directional pad's upper surface. Furthermore, one or more of the force-based action(s) can be prompted by pressing and/or releasing directional pad 10's upper surface 30a to cause a change in the force exerted on the upper surface. To illustrate, an avatar can be made to crouch when directional pad 10's upper surface 30a is pressed such that a first force is exerted on the upper surface, and can be made to jump by releasing the upper surface of the directional pad such that the force that the user exerts on the upper surface decreases or goes away (e.g., within a sufficiently-small time period).

To translate signal 114 that indicates the position at which an electrically-conductive object (e.g., a user's finger) touches upper surface 30a of directional pad 10 and the force exerted on the upper surface of the directional pad into touch-based and force-based actions in software application 126, information handling system 94 can include software such as an operating system 118 (e.g., executed by at least one of processor(s) 102) that can process the signal and an application programming interface (API) 122 that allows communication between the operating system and the software application. Operating system 118, which can recognize inputs made with directional pad 10, can thus communicate those inputs to software application 126 to cause the touch-based and force-based actions in the application.

Some of the present methods of controlling a software application (e.g., 126) (e.g., a gaming application) comprise touching one or more regions of an upper surface (e.g., 30a) of a directional pad (e.g., 10) of a controller (e.g., 54) and pressing and releasing the upper surface of the directional pad. As explained above, the touching can cause one or more touch-based actions in the software application, and the pressing and/or releasing can cause one or more force-based actions (e.g., a first force-based action when a first, larger force is exerted on the upper surface and a second, different force-based action when a second, smaller force is exerted on the upper surface) in the software application that are different than the touch-based action(s).

Referring to FIG. 4, as one example, the touch-based and force-based actions can relate to the control of an avatar (e.g., 130) of a gaming application. The avatar can be a character or thing that is controlled by the user and can be of any suitable form. Controllable avatars in gaming applications can include, for example, humans, animals, fanciful creatures, robots, vehicles, and/or the like. In the embodiment shown, pressing and/or releasing the upper surface of the directional pad can cause first and second force-based actions when first and second forces, respectively, are exerted on the directional pad's upper surface: the first force-based action can comprise moving the avatar in a first direction (e.g., 134a) and the second force-based action can comprise moving the avatar in a second direction (e.g., 134b) that is opposite and parallel to the first direction. The first direction can be, for example, forward movement while the second direction can be, for example, rearward movement (e.g., in directions that extend into and out of display 110). To illustrate, the user can press the upper surface of the directional pad to exert the first force on the upper surface and thereby cause the avatar to move in the first direction, and the user can release the upper surface without totally removing pressure to exert the second force on the upper surface and thereby cause the avatar to move in the second direction. Releasing the upper surface of the directional pad such that the upper surface is not touched can cause the avatar to pause, and exerting forces different than the first and second forces on the upper surface can cause the avatar to move in the first or second direction at different rates.

In the method shown, the one or more touch-based actions can comprise moving the avatar in greater than or equal to any one of, or between any two of, one, two, three, four, five, six, seven, eight, nine, ten, eleven, or twelve directions (e.g., 138a-138d). When the touch-based action(s) comprise moving the avatar in two or more directions (e.g., when the touching comprises touching two or more regions of the upper surface), the directions can be angularly disposed (e.g., with two, three, or four of the directions being orthogonal) and can each be substantially perpendicular to the first and second directions; for example, the touch-based actions can comprise moving the avatar in upward (e.g., 138a), downward (e.g., 138b), leftward (e.g., 138c), and/or rightward (e.g., 138d) directions. In this manner, the directional pad's combination of touch-based and force-based inputs can allow for 3-dimensional control of the avatar.

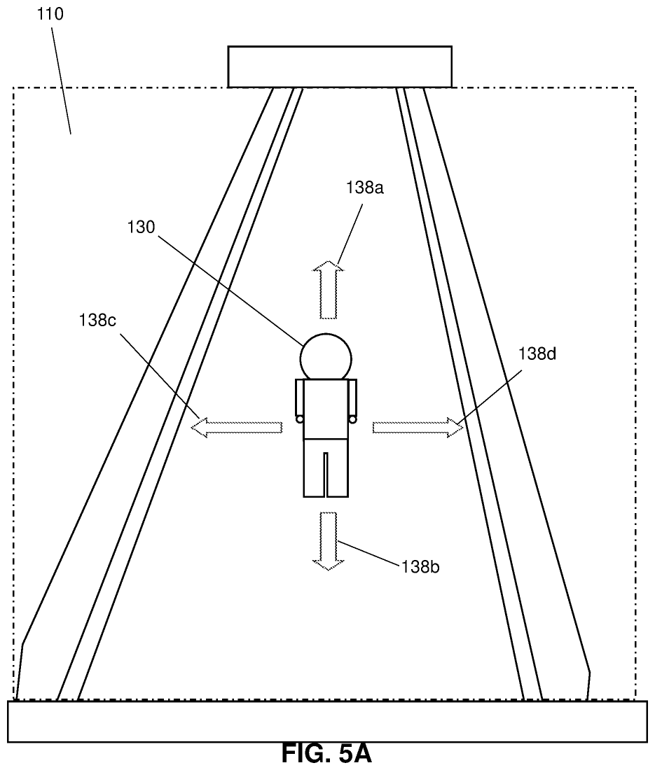

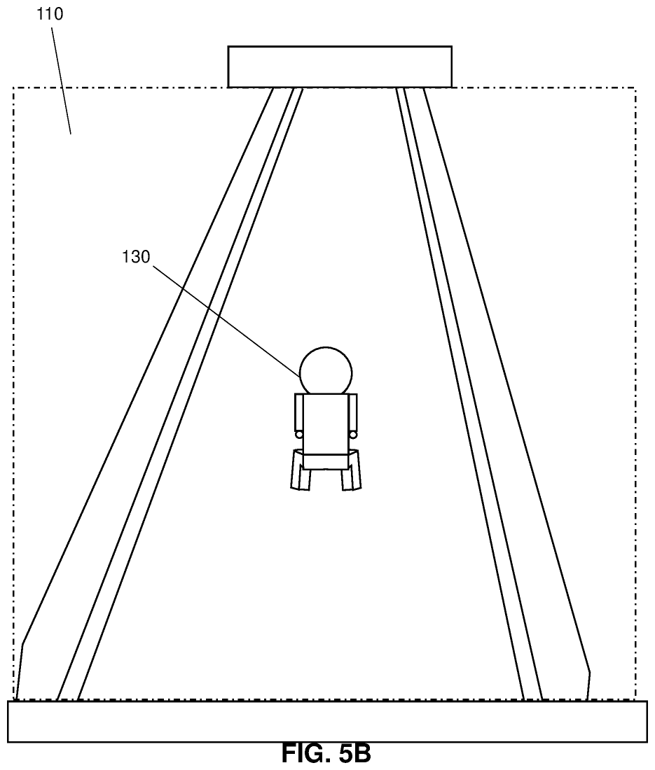

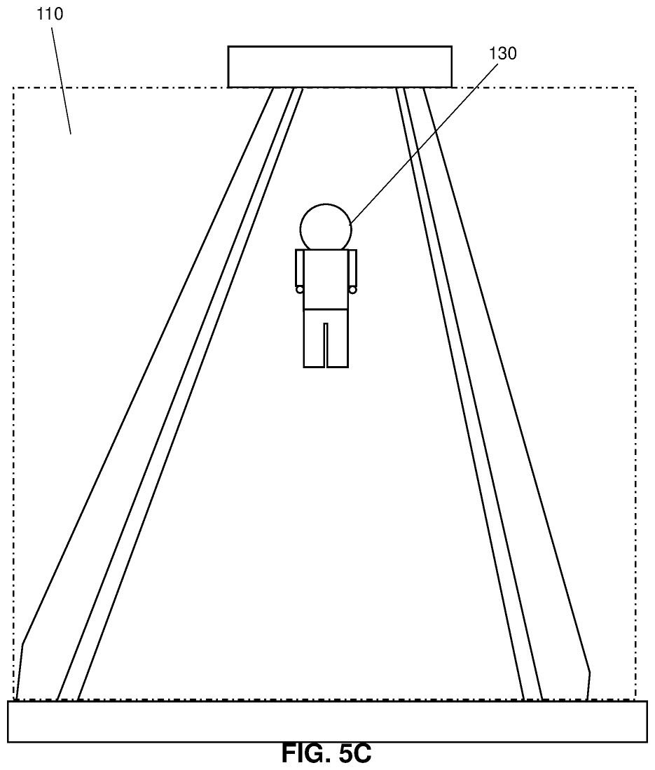

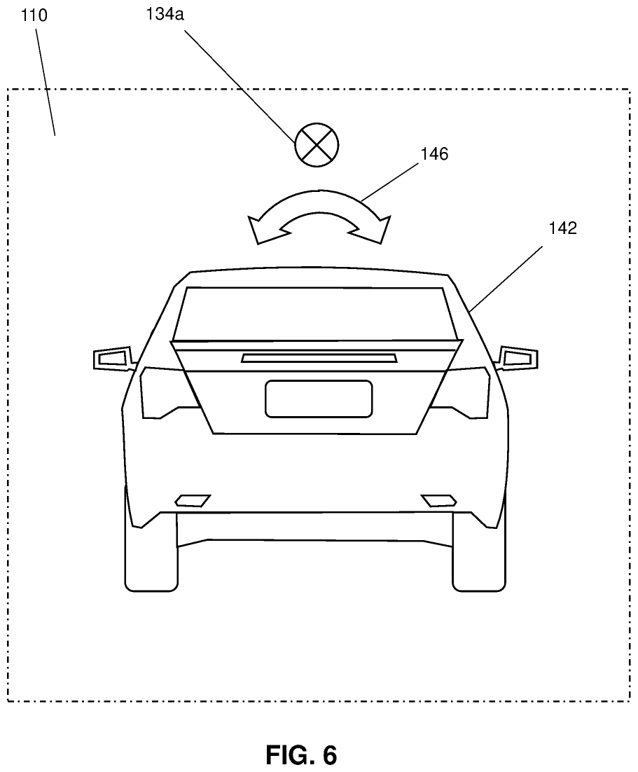

Referring to FIGS. 5A-5C, as another example, in some methods the touching, pressing, and releasing of the upper surface of the directional pad can be used to cause translational movement, crouching, and/or jumping of the avatar of the gaming application. In the method shown, and as with the method described above with reference to FIG. 4, the one or more touch-based actions can comprise moving the avatar in one or more directions (e.g., 138a-138d), optionally two or more directions (e.g., when the touching comprises touching two or more regions of the upper surface) that can be angularly disposed (e.g., with two, three, or four of the directions being orthogonal); for example, the touch-based actions can comprise moving the avatar in forward (e.g., 138a), rearward (e.g., 138b), leftward (e.g., 138c), and/or rightward (e.g., 138d) directions (FIG. 5A). The touch inputs into the directional pad can thus be used to translationally navigate the avatar. Meanwhile, the one or more force-based actions can comprise moving the avatar from a standing position (FIG. 5A) to a crouching position (FIG. 5B), which can be prompted by the user pressing on the upper surface of the directional pad; pressing further on the upper surface to exert a larger force on the upper surface can optionally cause the avatar to further move to a prone position. In some methods, the pressing and releasing can comprise releasing the directional pad's upper surface such that the upper surface is not touched, and the force-based action(s) can comprise, when this type of release occurs, causing the avatar to jump (FIG. 5C) (e.g., from the crouching position). In some methods, the jump is prompted when the time over which the release occurs (e.g., from the pressed condition in which the avatar is in the crouching position to the no-touch condition in which the upper surface of the directional pad is not touched) is below a threshold (e.g., with a fast-enough release to signal that the avatar should jump); when the time over which the release occurs is greater than or equal to the threshold, the avatar can return to the standing position without jumping (e.g., with a slow-enough release to signal that the avatar should not jump). The directional pad's force-based inputs can thus allow a user to use the directional pad to cause more than just translational movements of the avatar.

Referring to FIG. 6, shown is another illustrative method of controlling a gaming application, specifically a gaming application in which a user controls a vehicle (e.g., 142) like an automobile. The force-based action(s) can include the acceleration and deceleration of the vehicle, with the magnitude of the force exerted on the directional pad's upper surface optionally dictating the magnitude of the vehicle's acceleration. For example, in some methods, a first force-based action that occurs when the first, larger force is exerted on the directional pad's upper surface can comprise accelerating the vehicle (e.g., in first direction 134a) at a first rate and a second force-based action that occurs when the second, smaller force is exerted on the directional pad's upper surface can comprise accelerating the vehicle at a second rate that is slower than the first rate. There can be any suitable number of acceleration rates—each caused with a respective amount of force exerted on the directional pad's upper surface—to increase the vehicle's speed. In some methods, force-based actions comprise decelerating the vehicle; the deceleration can occur when releasing the upper surface of the directional pad such that the upper surface is not touched. In this manner, the pressing and releasing of the upper surface of the directional pad can be performed to control the speed of the vehicle in the gaming application.

In the method shown, the one or more touch-based actions can include steering the vehicle, which can be accomplished when, for example, the touching comprises touching two or more regions of the upper surface of the directional pad. For example, the user can touch a first region of the directional pad's upper surface and scroll across the upper surface (e.g., along an angular path) to a second region of the directional pad's upper surface; scrolling from the first region to the second region in a clockwise direction can cause the vehicle to steer to the right, and scrolling from the first region to the second region in a counterclockwise direction can cause the vehicle to steer to the left, as represented by arrow 146. As such, the directional pad's combination of touch-based and force-based inputs can allow a user to use the directional pad to control both the vehicle's speed and direction in the gaming application.

The above-described methods are provided by way of example to illustrate how the combination of touch-based and force-based inputs that are available using the directional pad can, compared to conventional directional pads, allow for a larger number of inputs that are still intuitively selectable to enhance a user's ability to control, for example, a gaming application. Any suitable combination of touch-based and force-based inputs can be employed to cause appropriate touch-based and force-based actions for a particular application.

Referring to FIG. 7, shown in further detail are components of an information handling system 94 that can execute a software application 126 to be controlled using controller 54. Information handling system 94 may include one or more processors 102 (e.g., a central processing unit (CPU) and/or a graphics processing unit (GPU)), a memory (e.g., a dynamic random-access memory (DRAM)) 704, and a chipset 706. In some embodiments, one or more of processor(s) 102, memory 704, and chipset 706 may be included on a motherboard (also referred to as a mainboard), which is a printed circuit board (PCB) with embedded conductors organized as transmission lines between the processor, the memory, the chipset, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of processor(s) 102, memory 704, chipset 706, and/or other components may be organized as a System on Chip (SoC).

At least one of processor(s) 102 may execute program code (e.g., for a software application like a gaming application) by accessing instructions loaded into memory 704 from a storage device, executing the instructions to operate on data also loaded into the memory from a storage device, and generate output data that is stored back into the memory or sent to another component. At least one of processor(s) 102 may include processing cores capable of implementing any of a variety of instruction set architectures (ISAs), such as the x86, POWERPC®, ARM®, SPARC®, or MIPS® ISAs, or any other suitable ISA. In multi-processor systems, multiple ones of processors 102 may commonly, but not necessarily, implement the same ISA. In some embodiments, multiple processors may each have different configurations such as when multiple processors are present in a big-little hybrid configuration with some high-performance processing cores and some high-efficiency processing cores. Chipset 706 may facilitate the transfer of data between at least one of processor(s) 102, memory 704, and other components. In some embodiments, chipset 706 may include two or more integrated circuits (ICs), such as a northbridge controller coupled to at least one of processor(s) 102, memory 704, and a southbridge controller, with the southbridge controller coupled to the other components such as USB 710, SATA 720, and PCIe buses 708. Chipset 706 may couple to other components through one or more PCIe buses 708.

Some components may be coupled to one bus line of PCIe buses 708, whereas some components may be coupled to more than one bus line of PCIe buses 708. One example component is a universal serial bus (USB) controller 710, which interfaces chipset 706 to a USB bus 712. A USB bus 712 may couple input/output components such as a keyboard 716, a mouse 716, and—if it is capable of a wired connection—controller 54, but also other components such as USB flash drives, or another information handling system. Another example component is a SATA bus controller 750, which couples chipset 706 to a SATA bus 722. SATA bus 722 may facilitate efficient transfer of data between chipset 706 and components coupled to the chipset and a storage device 106 (e.g., a hard disk drive (HDD) or solid-state disk drive (SDD)) and/or a compact disc read-only memory (CD-ROM) 726. PCIe bus 708 may also couple chipset 706 directly to a storage device 106 (e.g., a solid-state disk drive (SDD)). Further example components are one of processor(s) 102 that is a graphics device (e.g., a graphics processing unit (GPU)) for generating output to a display device 110, a network interface controller (NIC) 740, and/or a wireless interface 750 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

Chipset 706 may also be coupled to a serial peripheral interface (SPI) and/or Inter-Integrated Circuit (I2C) bus 760, which couples the chipset to system management components. For example, a non-volatile random-access memory (NVRAM) 770 for storing firmware 772 may be coupled to bus 760. As another example, a controller, such as a baseboard management controller (BMC) 780, may be coupled to the chipset 706 through bus 760. BMC 780 may be referred to as a service processor or embedded controller (EC). Capabilities and functions provided by BMC 780 may vary considerably based on the type of information handling system. For example, the term baseboard management system may be used to describe an embedded processor included at a server, while an embedded controller may be found in a consumer-level device. As disclosed herein, BMC 780 represents a processing device different from processor(s) 102, which provides various management functions for information handling system 94. For example, an embedded controller may be responsible for power management, cooling management, and the like. An embedded controller included at a data storage system may be referred to as a storage enclosure processor or a chassis processor.

Information handling system 94 may include additional processors that are configured to provide localized or specific control functions, such as a battery management controller. Bus 760 can include one or more busses, including a Serial Peripheral Interface (SPI) bus, an Inter-Integrated Circuit (I2C) bus, a system management bus (SMBUS), a power management bus (PMBUS), or the like. BMC 780 may be configured to provide out-of-band access to devices at information handling system 94. Out-of-band access in the context of the bus 760 may refer to operations performed prior to execution of firmware 772 by a processor 102 to initialize operation of information handling system 94.

Firmware 772 may include instructions executable by at least one of processor(s) 102 to initialize and test the hardware components of information handling system 94. For example, the instructions may cause at least one of processor(s) 102 to execute a power-on self-test (POST). The instructions may further cause at least one of processor(s) 102 to load a boot loader or an operating system (OS) from a mass storage device. Firmware 772 additionally may provide an abstraction layer for the hardware, such as a consistent way for application programs and operating systems to interact with the keyboard, display, and other input/output devices like controller 54. When power is first applied to information handling system 94, the system may begin a sequence of initialization procedures, such as a boot procedure or a secure boot procedure. During the initialization sequence, also referred to as a boot sequence, components of information handling system 94 may be configured and enabled for operation and device drivers may be installed. Device drivers may provide an interface through which controller 54 or other components of the information handling system 94 can communicate with a corresponding device. Firmware 772 may include a basic input-output system (BIOS) and/or include a unified extensible firmware interface (UEFI). Firmware 772 may also include one or more firmware modules of the information handling system. Additionally, configuration settings for the firmware 772 and firmware of the information handling system 94 may be stored in the NVRAM 770. NVRAM 770 may, for example, be a non-volatile firmware memory of the information handling system 94 and may store a firmware memory map namespace of the information handling system. NVRAM 770 may further store one or more container-specific firmware memory map namespaces for one or more containers concurrently executed by the information handling system.

Information handling system 94 may include additional components and additional busses, not shown for clarity. For example, information handling system 94 may include multiple processor cores (either within at least one of processor(s) 102 or separately coupled to chipset 706 or through the PCIe buses 708), audio devices (such as may be coupled to chipset 706 through one of PCIe busses 708), or the like. While a particular arrangement of bus technologies and interconnections is illustrated for the purpose of example, one of skill will appreciate that the techniques disclosed herein are applicable to other system architectures. Information handling system 94 may include multiple processors and/or redundant bus controllers. In some embodiments, one or more components may be integrated together in an integrated circuit (IC), which is circuitry built on a common substrate. For example, portions of chipset 706 can be integrated within at least one of processor(s) 102. Additional components of information handling system 94 may include one or more storage devices that may store machine-executable code, one or more communications ports for communicating with external devices, and various input and output (I/O) devices, such as a keyboard, a mouse, and a video display.

In some embodiments, at least one of processor(s) 102 may include multiple processors, such as multiple processing cores for parallel processing by information handling system 94. In some embodiments, information handling system 94 may support virtual machine (VM) operation, with multiple virtualized instances of one or more operating systems executed in parallel by the information handling system 94. For example, resources, such as processors or processing cores of the information handling system may be assigned to multiple containerized instances of one or more operating systems of the information handling system 94 executed in parallel. A container may, for example, be a virtual machine executed by the information handling system 94 for execution of an instance of an operating system by the information handling system. Thus, for example, multiple users may remotely connect to information handling system 94, such as in a cloud computing configuration, to utilize resources of the information handling system, such as memory, processors, and other hardware, firmware, and software capabilities of the information handling system 94. Parallel execution of multiple containers by the information handling system 94 may allow the information handling system to execute tasks for multiple users in parallel secure virtual environments.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the products, systems, and methods are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A directional pad for a controller, the directional pad comprising:
an upper surface;
a touch sensor that is configured to measure a position at which an electrically-conductive object touches the upper surface of the directional pad; and
a force sensor that is configured to measure a force exerted on the upper surface of the directional pad.

2. The directional pad of claim 1, wherein the force sensor comprises a piezoelectric force sensor.

3. The directional pad of claim 1, wherein the touch sensor comprises a capacitive touch sensor.

4. The directional pad of claim 1, wherein the upper surface of the directional pad has a circular planform.

5. The directional pad of claim 1, comprising a linear resonant actuator that is configured to vibrate the upper surface of the directional pad in a direction that is substantially parallel with a vertical axis that extends through the upper surface of the directional pad.

6. A system comprising:
an information handling system configured to execute a software application, the information handling system including one or more processors, wherein at least one of the processor(s) is in electrical communication with an electronic display; and
a controller comprising:
a body;
a plurality of buttons coupled to the body; and
a directional pad coupled to the body and comprising:
an upper surface;
a touch sensor that is configured to measure a position at which an electrically-conductive object touches the upper surface of the directional pad; and
a force sensor that is configured to measure a force exerted on the upper surface of the directional pad;
wherein:
the controller is configured to send a signal to the information handling system that indicates:
the position at which the electrically-conductive object touches the upper surface of the directional pad; and
the force exerted on the upper surface of the directional pad; and
the information handling system is configured to cause:
one or more touch-based actions in the software application based on the position at which the electrically-conductive object touches the upper surface of the directional pad; and
one or more force-based actions in the software application based on the force that is exerted on the upper surface of the directional pad, wherein the force-based action(s) are different than the touch-based actions.

7. The system of claim 6, wherein the one or more force-based actions comprise:
a first force-based action that is caused when a first force is exerted on the upper surface of the directional pad; and
a second force-based action that is different than the first force-based action and is caused when a second force that is less than the first force is exerted on the upper surface of the directional pad.

8. The system of claim 6, wherein the software application is a gaming application.

9. The system of claim 6, wherein the force sensor comprises a piezoelectric force sensor.

10. The system of claim 6, wherein the touch sensor comprises a capacitive touch sensor.

11. The system of claim 6, wherein the directional pad comprises a linear resonant actuator that is configured to vibrate the upper surface of the directional pad in a direction that is substantially parallel with a vertical axis that extends through the upper surface of the directional pad.

12. The system of claim 6, wherein:
the body of the controller has a main portion disposed between first and second gripping portions, each of the gripping portions projecting rearwardly away from the main portion;
the directional pad is disposed:
closer to the first gripping portion than to the second gripping portion; and
closer to a front of the body than to a rearmost point of the first gripping portion; and
the buttons include four buttons that are each disposed:
closer to the second gripping portion than to the first gripping portion; and
closer to the front of the body than to a rearmost point of the second gripping portion.

13. A method of controlling a software application, the method comprising:
touching one or more regions of an upper surface of a directional pad of a controller, wherein the touching causes one or more touch-based actions in the software application; and
pressing and releasing the upper surface of the directional pad, wherein the pressing and/or releasing cause one or more force-based actions in the software application that are different than the touch-based actions(s).

14. The method of claim 13, wherein:
pressing and releasing the directional pad is performed such that first and second forces are exerted on the upper surface of the directional pad, the second force being less than the first force; and
the one or more force-based actions comprise:
a first force-based action that is caused when the first force is exerted on the upper surface of the directional pad; and
a second force-based action that is different than the first force-based action and is caused when the second force is exerted on the upper surface of the directional pad.

15. The method of claim 14, wherein:
the software application is a gaming application;
the first force-based action comprises moving an avatar of the gaming application in a first direction; and
the second force-based action comprises moving the avatar of the gaming application in a second direction that is opposite and parallel to the first direction.

16. The method of claim 15, wherein the one or more touch-based actions comprise moving the avatar of the gaming application in one or more directions that are each substantially perpendicular to the first and second directions.

17. The method of claim 14, wherein:
the software application is a gaming application;
the touching comprises touching two or more regions of the upper surface of the directional pad;
the one or more touch-based actions comprise steering a vehicle of the gaming application;
the first force-based action comprises accelerating the vehicle of the gaming application at a first rate; and
the second force-based action comprises accelerating the vehicle of the gaming application at a second rate that is slower than the first rate.

18. The method of claim 17, wherein:
the pressing and releasing comprise releasing the upper surface of the directional pad such that the upper surface is not touched; and
the force-based actions comprise decelerating the vehicle of the gaming application when the upper surface of the directional pad is released such that the upper surface is not touched.

19. The method of claim 13, wherein:
the software application is a gaming application,
the touching comprises touching two or more regions of the upper surface of the directional pad;
the one or more touch-based actions comprise moving an avatar of the gaming application in two or more angularly-disposed directions; and
the one or more force-based actions comprise moving the avatar of the gaming application from a standing position to a crouching position.

20. The method of claim 19, wherein:
the pressing and releasing comprise releasing the upper surface of the directional pad such that the upper surface is not touched; and
the one or more force-based actions comprise causing the avatar of the gaming application to jump when the upper surface of the directional pad is released such that the upper surface is not touched.
